(19) United States
(12) Patent Application Publication
(10) Pub. No.: US 2010/0199750 A1
(43) Pub. Date: Aug. 12, 2010

(54) Microfludic Analysis System and Method

(76) Inventors: Don W. Arnold, Livermore, CA (US); Nicole E. Hebert, Livermore, CA (US); Patrick Leung, San Bruno, CA (US); David W. Wyrick, San Francisco, CA (US); Phillip H. Paul, San Francisco, CA (US)

Correspondence Address: EKSIGENT TECHNOLOGIES, LLC;c/o SHELDON MAK ROSE & ANDERSON, 100 Corson Street, Third Floor, PASADENA, CA, 91103-3842, US

(21) Appl. No.: 12/367,407

(22) Filed: Feb. 6, 2009

(51) Int. Cl. G01N 30/02; G01N 27/26

(52) U.S. Cl. 73/61.56; 204/400

(57) ABSTRACT

A microfluidic processing system having a manifold with at least one inlet; at least one outlet; and a plurality of microfluidic chip holders. A fluidic jumper is coupled to one of the chip holders and at least two fluidic elements are coupled to at least one of the chip holders. The fluidic jumper controls the fluidic path through the system.

### BACKGROUND

The present invention relates to microfluidic systems, and more specifically to microfluidic analysis systems utilizing microfluidic chips.

Microfluidics holds promise as a tool to improve workflow and reduce cost for a wide spectrum of processes through integration and reduction of necessary reagents. However, there is a tradeoff between flexibility and ease of use. Many existing microfluidic systems are very inflexible to make them simpler to operate. This is a result of the poor quality of the microfluidic chip to world interface (the connections for moving fluids to and from the microfluidic chip), where connections can result in numerous problems such as carryover, sample loss, leaking of fluid, or a loss of performance due to interface geometry. These interfaces are therefore minimized, leading to the placement of all necessary fluidic elements onto a single microfluidic chip device.

In addition to the lack of flexibility of traditional microfluidic systems, a problem arises when the lifetimes of the fluidic elements differ. The entire microfluidic system fails as soon as the failure of the element with the shortest lifetime. This often requires disposal of the entire system much sooner than desired or warranted by those fluidic elements with longer lifetimes. Indeed, for workflows in which different fluidic elements have drastically different lifetimes, this is a very wasteful and expensive problem.

There is therefore a need for an apparatus that solves the shortcomings of the prior art.

### SUMMARY

Accordingly, the present invention is directed to a system in which a manifold with multiple connectors is used to make connections between fluid sources and fluid destinations and a family of microfluidic chips for various workflows. The family of chips contains two or more classes of chips, functional microfluidic chips having fluidic elements such as separation columns and sample preparation chips and fluid routing chips known as fluidic jumpers. The microfluidic chips and fluid sources are coupled to the fluid manifold. Depending on the microfluidic chips used, a user can carry out different functional workflows.

The present invention, according to an embodiment, is directed to a microfluidic processing system having a manifold with at least one inlet; at least one outlet; and a plurality of microfluidic chip holders. A fluidic jumper is coupled to one of the chip holders and at least two fluidic elements are coupled to at least one of the chip holders. The fluidic jumper controls the fluidic path through the system. The at least two fluidic elements may be on a single microfluidic chip. Additionally, the at least two fluidic elements may comprise at least one fluidic element on each of two separate microfluidic chips.

At least one of the fluidic elements may be a reaction chamber, a sample preparation chamber, a trap or a liquid chromatograph. Additionally, at least one of the fluidic elements may be a filter, a chromatograph, a bead catcher, an optical sensor, an electrochemical sensor, a temperature sensor and a flow sensor. The fluidic jumper may cause the fluid to pass through the at least two fluidic elements in series or in parallel.

At least one fluid source may be coupled to at least one inlet. The system can also have a valve between the at least one fluid source and the inlet to which the fluid source is coupled. At least one destination may be coupled to at least one outlet.

Optionally, the fluidic jumper and the fluidic elements may be mounted in chip caddies. Optionally, the fluidic jumper and the fluidic elements may have a memory encoded with information. Optionally, the system has a heating or cooling element for affecting the temperature of at least one fluidic element. In an embodiment of the present invention, the manifold has releasable mechanical retainers for retaining the fluidic jumper and the fluidic elements.

The present invention is also directed to a method for analyzing fluids. The method comprises the steps of: selecting an apparatus having a manifold with at least one inlet; at least one outlet; a plurality of microfluidic chip holders; at least one fluidic jumper coupled to one of the chip holders; and at least two fluidic elements coupled to at least one chip holder. The method further comprises coupling at least one fluid source to at least one inlet; passing fluid from the fluid source through the fluidic jumper, at least one of the two fluidic elements and out of at least one outlet; and determining at least one characteristic of the fluid after it passes through at least one of the fluidic elements.

The method may further comprise the step of removing the fluidic jumper and replacing the fluidic jumper with a second fluidic jumper to alter the flowpath through the system. Additionally, the method may comprise removing at least one of the fluidic elements and replacing the removed fluidic element with a different fluidic element. Additionally, the system may have a heating or cooling element for affecting the temperature of at least one fluidic element; and the method may further comprise the step of heating or cooling at least one fluidic element to alter the fluid passing therethrough.

Additionally, the present invention is directed to a kit for performing microfluidic analysis. The kit has a manifold with at least one inlet; at least one outlet; and a plurality of microfluidic chip holders. The kit further includes at least one fluidic jumper connectable to the chip holders; and a plurality of different fluidic elements connectable to at least one of the chip holders. At least one fluidic jumper is usable to dictate the fluidic path through the manifold and fluidic elements. Optionally, the kit further comprises a plurality of different fluidic jumpers connectable to the chip holders.

### BRIEF DESCRIPTION OF THE DRAWINGS

A better understanding of the present invention will be had with reference to the accompanying drawings in which:

FIG. 1 is a schematic diagram of a microfluidic system according to a first embodiment of the present invention having fluidic elements in serial flow;

FIG. 2 is a schematic diagram of a microfluidic system according to a second embodiment of the present invention having fluidic elements in parallel flow; and

FIG. 3 is a schematic diagram of a microfluidic system according to a third embodiment of the present invention having fluidic elements in serial flow;

FIG. 4A to 4C are schematic diagrams of microfluidic systems according to embodiments of the present invention for proteomic applications;

FIG. 5 is two chromatographs showing the effect of a fluidic jumper on measurements from a trap and elute experiment;

FIG. 6 is two chromatographs showing the effect of a fluidic jumper on measurements from a direct injection experiment; and

FIG. 7 is three chromatographs showing the effect of a fluidic jumper on a two column switching experiment.

### DETAILED DESCRIPTION

Definitions

In the Summary of the Invention above, the Detailed Description of the Invention, and the Claims below, and the accompanying drawings, reference is made to particular features of the invention, such features including for example aspects, components, ingredients, devices, apparatus, systems, steps and embodiments. It is to be understood that the disclosure of the invention in this specification includes all possible combinations of such particular features. For example, where a particular feature is disclosed in the context of a particular aspect, a particular embodiment, a particular Figure, or a particular claim, that feature can also be used, to the extent possible, in the context of other particular aspects, embodiments, Figures and claims, and in the invention generally. The invention claimed herein includes the use of features which are not specifically described herein but which provide functions which are the same as, equivalent to, or similar to, features specifically described herein.

The term “comprises” and grammatical equivalents thereof are used herein to mean that other features are optionally present. For example, an assembly “comprising” (or “which comprises”) components A, B and C can contain only components A, B and C, or can contain not only components A, B and C but also one or more other components. Where reference is made herein to a method comprising two or more defined steps, then, unless the context requires otherwise, the defined steps can be carried out in any order or simultaneously, and the method can include one or more other steps which are carried out before any of the defined steps, between two of the defined steps, or after all the defined steps. The term “at least” followed by a number is used herein to denote the start of a range beginning with that number (which may be a range having an upper limit or no upper limit, depending on the variable being defined). For example “at least 4” means 4 or more than 4, and “at least 80%” means 80% or more than 80%. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number)”, this means a range whose lower limit is the first number and whose upper limit is the second number. For example, “from 6 to 500” or “6-500” means a range whose lower limit is 6 and whose upper limit is 500. The numbers given herein should be construed with the latitude appropriate to their context and expression. The terms “plural” and “plurality” are used herein to mean two or more.

When reference is made herein to “a”, “an”, “one” or “the” feature, it is to be understood that, unless the context requires otherwise, there can be one or more than one such feature. For example, when reference is made herein to a feature selected from a list of features, it is to be understood that, unless the context requires otherwise, the feature can be a single one of the listed features or two or more of the listed features.

Where reference is made herein to two or more components (or parts or portions etc.), it is to be understood that the components can be, unless the context requires otherwise, separate from each other or integral parts of a single structure or a single component acting as the two or more specified components.

When reference is made to two components being coupled together, it is to be understood that the two components are in fluid communication with each other and can be directly or indirectly connected to each other.

The Invention

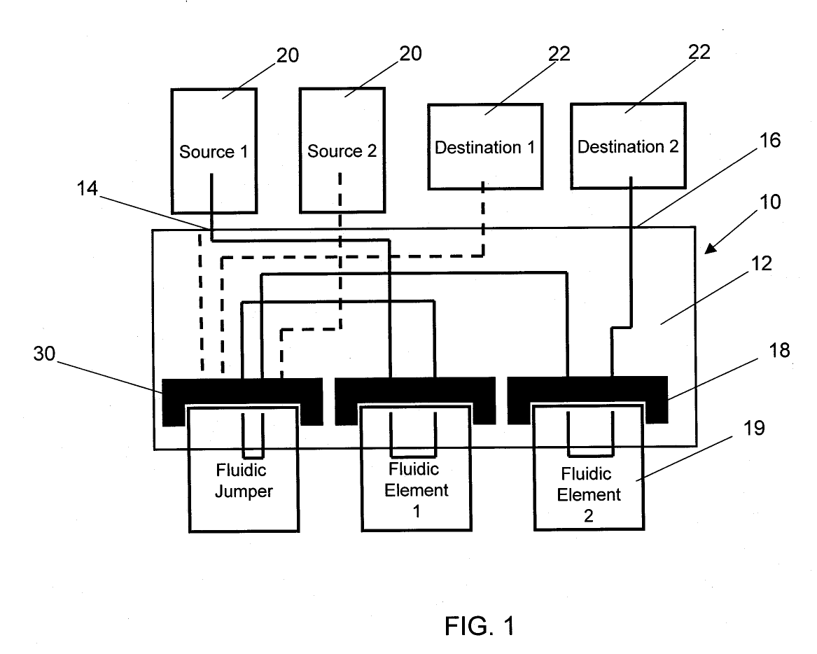

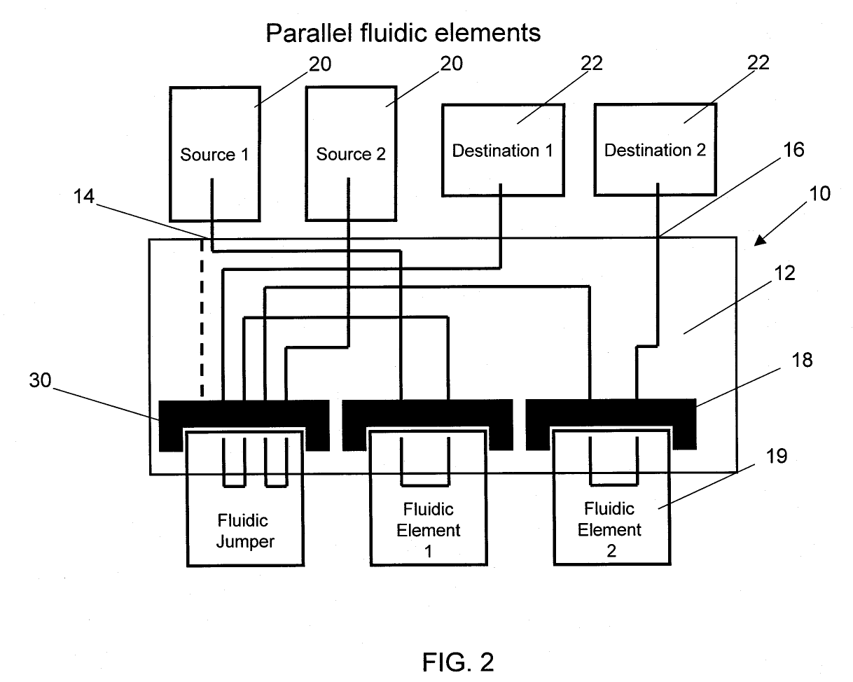

As seen in FIGS. 1 to 3, the present invention, according to various embodiments, is directed to a microfluidic system 10. The system has a manifold 12 to which the other components are coupled. The manifold 12 has at least one fluid inlet 14 and at least one fluid outlet 16. Additionally, the manifold 12 has a plurality of chip holders 18 where microfluidic chips 19 can be coupled to the manifold. At least one fluid inlet 14 can be connected to a fluid source 20. At least one outlet 16 can be connected to an output destination 22. In preferred embodiments, the manifold has a plurality of inlets 14 connected to a plurality of fluid sources 20 and a plurality of outlets connected to a plurality of destinations. As will be understood by those of skill in the art, various pumping systems, valves and sample injectors can be positioned between the fluid sources 20 and the inlets 14.

The term “microfluidic chip” is used herein to denote a substrate containing a microfluidic conduit. Microfluidic chips usable with the present invention fall into two categories. The first category is a fluidic element containing chip. The fluidic elements are designed to perform a function, such as chemical synthesis, sample preparation, liquid chromatographic analysis, etc. The second category is a fluidic jumper that dictates the fluidic path through the system.

The fluidic element chips may contain one or more fluidic elements such as micro-mixers or splitters, microvalves, filters, chromatographs, bead catchers, digesters, passive or active flow control elements, such as electrokinetic flow control elements, detectors or sensors, such as optical, electrochemical, temperature, flow or pressure sensors. The fluidic jumper chip may also have one or more fluidic elements.

Preferably, fluidic elements are isolated onto separate microfluidic chips so that the fluidic elements may be changed independently. Flexibility in the choice of experiment is achieved through the use of different fluidic jumper chips. By providing a family of fluidic elements and fluidic jumpers, a user may easily reconfigure the system for different workflows.

One skilled in the art will recognize that multiple fluidic elements can be placed on a single fluidic element chip and different fluidic jumper chips used to configure different workflows from that fluidic element chip. For example, fluidic element 1 and fluidic element 2 shown in FIG. 1 can be placed on a single microfluidic chip.

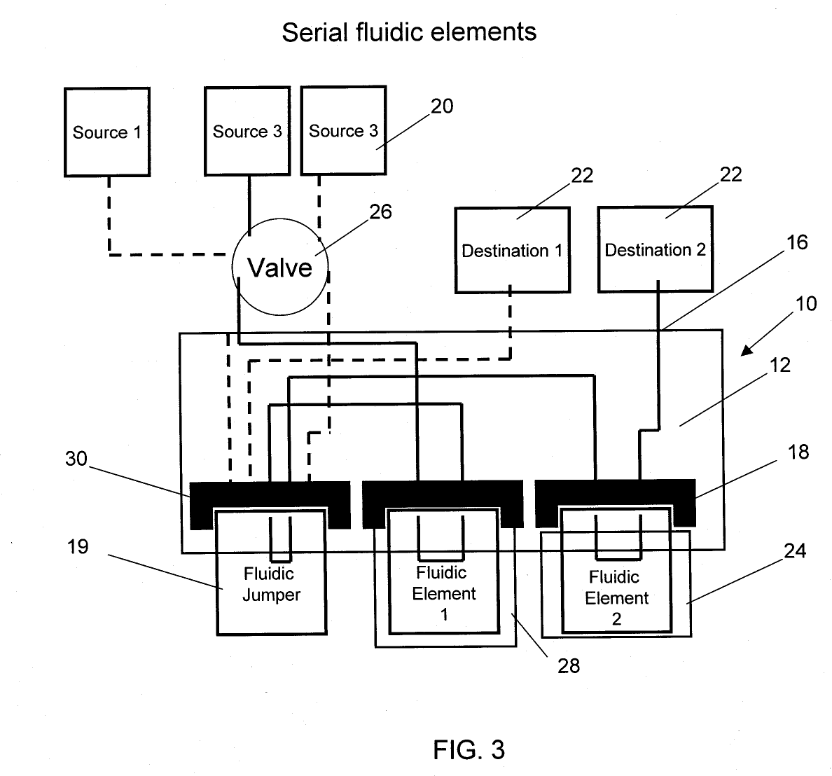

The number of fluidic elements and fluidic jumpers can be increased to facilitate the use of the system for numerous applications. There is no known practical limit to the number of microfluidic chips that can be used with the present invention. As shown in FIG. 3, the system may contain a heating and/or cooling element 24 for one or more of the microfluidic chips connected to the manifold. Additionally, the system may have a strain gauge (not shown) for one or more of the microfluidic chips connected to the manifold.

As shown in FIG. 3, additional functionality can be provided to the system through the addition of a valve 26 for the fluid sources 20. The valve 26 may be conventional or microfluidic based.

As will be understood by those of skill in the art, microfluidic chips usable with the present invention may be manufactured in multiple different ways, including, for example by photolithography, glass etching, ceramic etching, metal etching, deposition and bonding, PDMS processing, stereolithography, electroplating, injection molding and embossing.

In an embodiment, the microfluidic chips are prepared by a method comprising:
(1) etching (or otherwise producing) a first three-dimensional pattern on a face of a first wafer;
(2) providing a second wafer, and optional etching (or otherwise producing) a second three-dimensional pattern on a face of the second wafer, the second pattern optionally comprising a part which is substantially a mirror image of at least part of the first pattern;
(3) securing together the etched face of the first wafer and a face of the second wafer; thus forming the microchip which includes microfluidic conduits, namely an elongate conduit of circular or non-circular cross-section having an equivalent diameter of at most 1.0 mm.

The wafers can be composed of any ceramic materials which can be etched or otherwise treated to produce desired patterns, including for example silica, silicon, glass, quartz and alumina. The microfluidic chips can be provided with alignment features to help users place the chips in the manifold and in chip caddies as will be further described below. Suitable alignment features are known in the art and are taught, for example, in U.S. patent application Ser. No. 10/599,591, entitled Microfluidic Connections, the entire contents of which are incorporated herein by reference for all purposes.

For example, the alignment features may be grooves in the side faces of the microfluidic chips. Each of the chip holders in the manifold may have a pair of flanges which are separated from each other by a constant distance, and have thin edge portions that fit slidably into the grooves, and which generally lie in the same plane. The thickness of the edge portions should be somewhat less than, e.g. 10 to 30 micrometers less than, the height of the groove. The distance between the flanges should be slightly greater than, for example 20 to 40 micrometers greater than, the distance between the grooves. The flanges can be of uniform thickness, or can have relatively thin edge portions and relatively thick body portions to make the flanges more rigid. One or both of the flanges can have a tapered end portion, e.g. a rounded corner, to help the substrate to enter the gap between the flanges. One or both of the flanges can be substantially shorter than the other, so that at least part, e.g. 50 to 100%, of one groove of the microfluidic chip can be fitted over the longer flange, and the other groove thereafter fitted over the shorter flange as the microfluidic chip is pushed between the flanges.

The flanges are preferably composed of a metal, particularly an alloy metal, or other rigid material which can be fabricated with a high degree of dimensional accuracy. Suitable fabrication methods include conventional machining, laser machining, and chemical etching. Photochemical etching is particularly preferred because very good dimensional tolerances can be achieved, and because it does not induce the mechanical and/or thermal stresses that can be induced by conventional machining and laser machining.

### Chip Caddies

Microfluidic chips are often small and quite difficult to handle. It may be desirable, therefore, to mount the microfluidic chips in a carrier 28 which can be more easily handled and inserted into the manifold, and which does not interfere with the operations of the microfluidic chips. Such carriers are referred to herein as chip caddies. Particularly useful chip caddies are generally U-shaped bodies having legs which fit into grooves of a microfluidic chip having grooves in its side faces and which have a length such that when the microfluidic chip is fully engaged by the caddy (i.e. the face of the microfluidic chip opposite the mating face is pressed against the base of the U), a substantial proportion of each of the grooves remains exposed. Such a chip caddy can be used in conjunction with a manifold having flanges as described above, preferably one having legs whose ends are shaped to accommodate the chip caddy as the exposed portions of the grooves of the microfluidic chip, carried by the caddy, are pushed between the flanges.

Optionally, the chip caddy can have a memory, such as an EEPROM. The memory can store information about the type of microfluidic chip in the caddy so that a check can be performed as to whether the correct microfluidic chips are being used for the desired experiment. Additionally, the memory can store usage information for the microfluidic chip contained in the caddy. Preferably, the memory is read/write accessible to a computer associated with the manifold, although the memory can be accessible to other computers as well. The memory can define the range of different experiments that can be conducted with the microfluidic chip in the caddy and can provide direction to the other components of the system that must be in a specific state for that experiment, such as a valve.

### Connections Between the Microfluidic Chips and the Manifold

The microfluidic chips utilized in the present invention have microfluidic conduits that must be connected to the manifold. The making of junctions comprising micro fluidic conduits (for example junctions between a micro fluidic conduit and a conventional elongate component, e.g. a capillary tube, optical fiber or electrical lead) may be difficult. The problems increase when a plurality of closely-spaced junctions must be made, and/or it is desirable to make a junction which can be disassembled, e.g. to remove debris or to replace disposable or modular components or parts. Known methods of making such junctions are disclosed, for example, in U.S. Pat. Nos. 6,605,472, 6,319,476, 6,620,625 and 6,832,787, U.S. Patent Application Publication Nos. US 2002/0043805 and 2003/0173781, International Publication Nos. WO/98/25065, WO/98/33001, WO 00/52376, WO 01/86155, and WO 02/070942, Sensors and Actuators B 49, 40-45 (1998) (Gonzales et al), Anal. Methods Instrum. 2 (1995) 74 (Ockvirk et al), Anal. Chem. 71, 3292 (1999) (Bings et al), Lab-on-a-Chip 1, 148-152 (2001) (Nittis et al), J. Micromech. Microeng. 11, 577 (2001) (Tsai et al), J. Micromech. Microeng. 13, 337 (2003) (Pattekar et al), and Lab-on-a-Chip 2, 42-47 (2003) (Kopf-Sill), the entire disclosures of which are incorporated herein by reference for all purposes.

Preferably, the connections between the microfluidic chips and the manifold (and optionally between the fluid sources and the manifold) are made according to the teachings of U.S. patent application Ser. No. 10/599,591 entitled Microfluidic Connections, the entire contents of which are incorporated herein by reference for all purposes.

Retaining the Seal between the Manifold and the Microfluidic Chips

During use of the invention, the microfluidic chips are usually maintained in relative positions such that a fluid-tight seal between the microfluidic chips and the manifold is retained. The retention can be substantially permanent, or can be releasable, so that the microfluidic chips can be separated from each other and from the manifold, for example for cleaning and/or replacement of one of the microfluidic chips.

Releasable retention can be achieved, for example, through the use of releasable mechanical retainers 30 on the manifold. In some embodiments, the retainer(s) engage(s) each microfluidic chip. In other embodiments, the retainer(s) engage(s) the chip caddy associated with each microfluidic chip. The retainers can cooperate with the boundaries of microfluidic chips and/or chip caddies, and/or with features, e.g. grooves or holes, formed for this purpose in the microfluidic chips and/or the chip caddies. The retainers can be elastically deformed so that they do not contact the microfluidic chip while the microfluidic chip is being joined to the substrate, but snap into a retaining configuration when a fluid-tight seal has been achieved between the microfluidic chip and the manifold. Alternatively or additionally, the retainers can be secured in place by screws or any other form of releasable fastener.

### Applications of the System

Proteomics

According to embodiments of the present invention, the system 10 may be used in the field of proteomics. The field of proteomics research relies heavily on the use of mass spectrometers. Optimal performance of these instruments is achieved as the flow rate of the eluate to be ionized decreases. The desire to use low flow rates dictates the column diameter of the chromatography system used for separation prior to detection, forcing the use of small internal diameter columns.

When using low flow rates and small column diameters, the characteristics of the fluidic path through which the analytes pass is critical for good performance. This makes any change in the fluidic path, whether for changing equipment or experiment type, time consuming and very user sensitive. Additionally, the different fluidic elements used in proteomics analyses have drastically different lifetimes, which make their separation onto individual microfluidic chips advantageous.

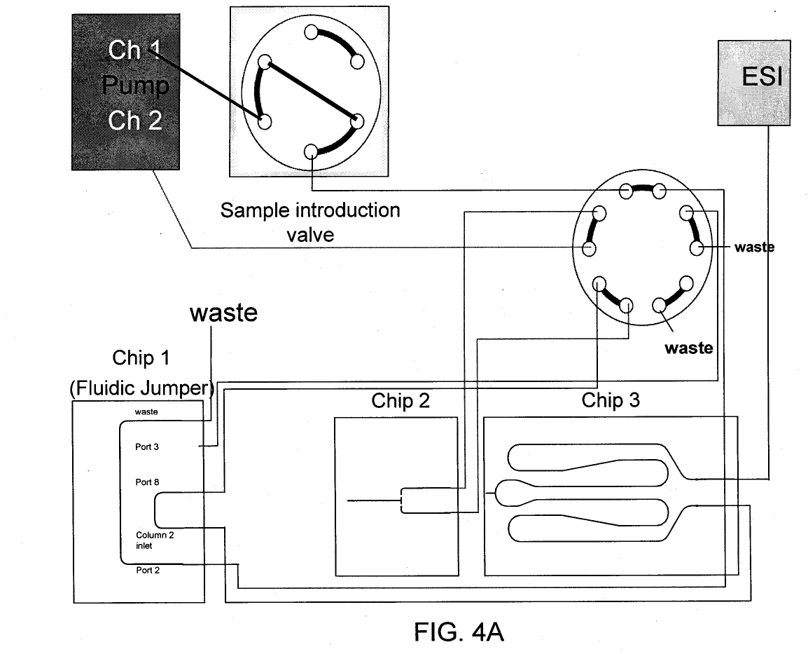

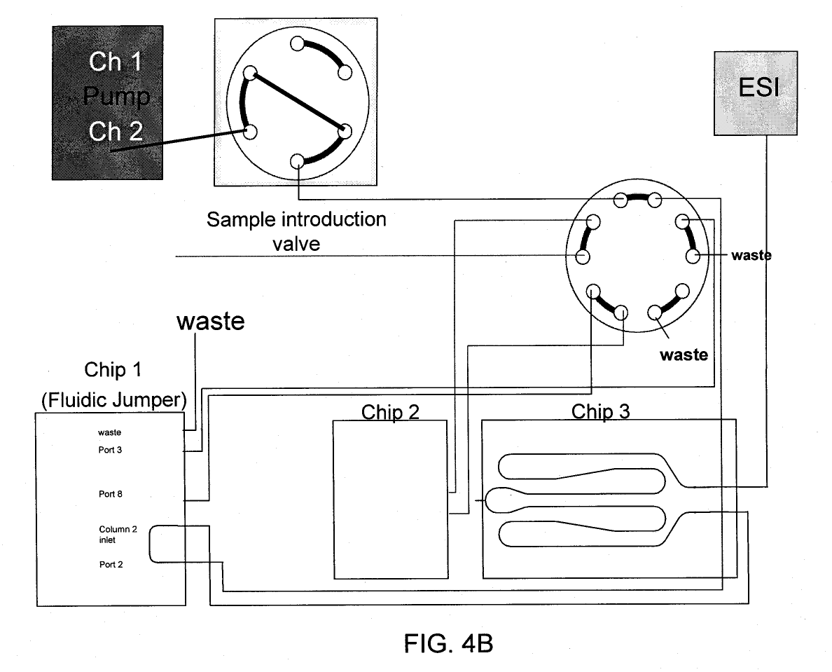

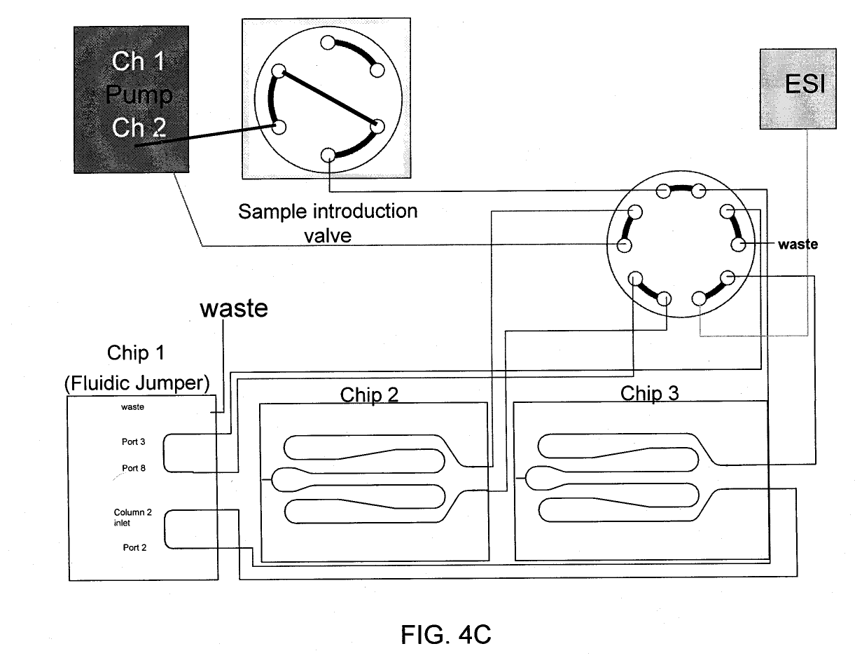

An example of this type of system, which additionally uses a 10-port two position valve, is shown in FIGS. 4A-C. Additional components that are used in a typical system include: a pumping system, a sample introduction valve, and a mass spectrometer.

Each microfluidic chip is plumbed to specific ports of the valve either by the manifold or by the manifold in conjunction with one of the other microfluidic chips. Microfluidic chip 1 has five fluidic connections, while microfluidic chips 2 and 3 each have two fluidic connections. FIGS. 4A-C illustrate the use of the system to perform three common proteomics experiments: trap and elute (FIG. 4A), direct on column injection (FIG. 4B) and two column switching (FIG. 4C).

Microfluidic chip 1 is the fluidic jumper chip, which differs for each experiment. Microfluidic chip 2 contains a trap column in the trap and elute experiment diagrammed in FIG. 4A, contains no fluidic element in the direct on column injection experiment diagrammed in FIG. 4B, and contains an analytical column in the two column switching experiment diagrammed in FIG. 4C. Microfluidic chip 3 contains an analytical column in all three experiments.

Microfluidic chips 2 and 3 may also be equipped with contact heating and/or cooling elements which allow their temperature to be controlled independently. This allows for thermostatting of the analytical column(s) and also for thermostatting of the trap to either increase the retention to improve capacity or to decrease the retention (compared to the analytical column) to improve data quality. All connectors may be equipped with a strain gauge that provides feedback on the compression of gaskets used to seal the microfluidic chips to the manifold, to be used in an interlock circuit and for other possible applications.

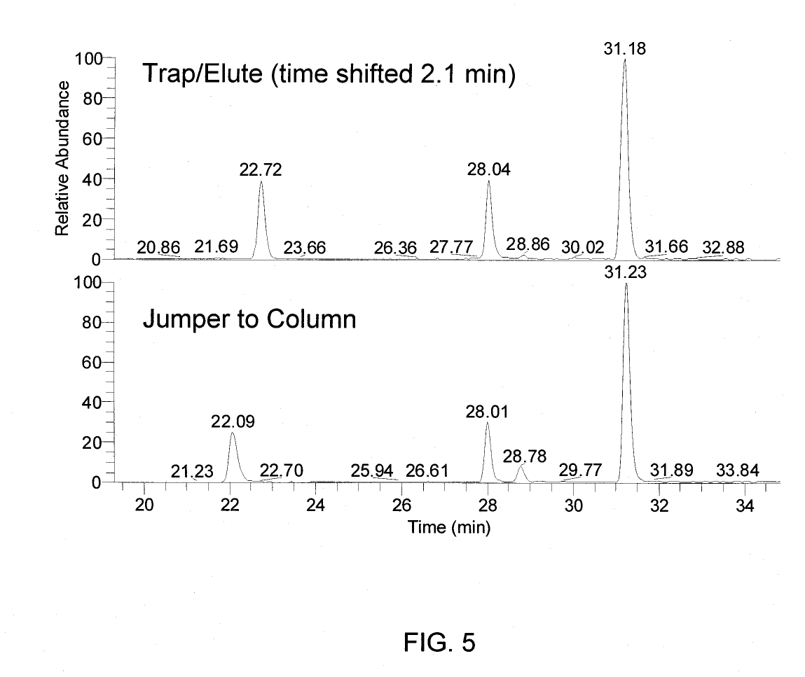

Data for a system having a manifold in conjunction with a fluidic jumper is shown in FIGS. 5 to 7. FIG. 5 contains two chromatograms that were collected for trap and elute experiments of a five component peptide mixture. The top panel was collected using traditional trap and elute plumbing, without the use of a fluidic jumper. The bottom panel was collected with a fluidic jumper, in the configuration diagrammed in FIG. 4A. Aside from an increase in delay volume due to the extra tubing, the peaks are very similar, indicating that there are no deleterious effects of the use of the fluidic jumper.

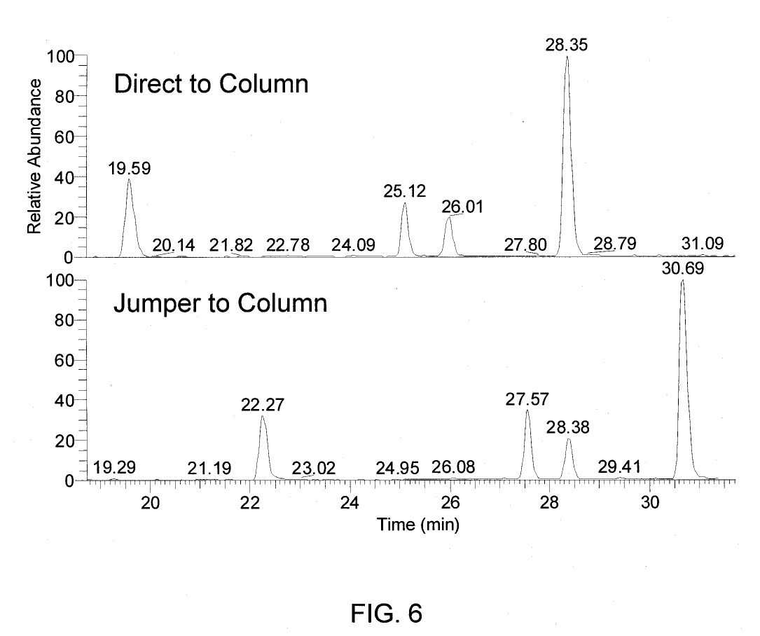

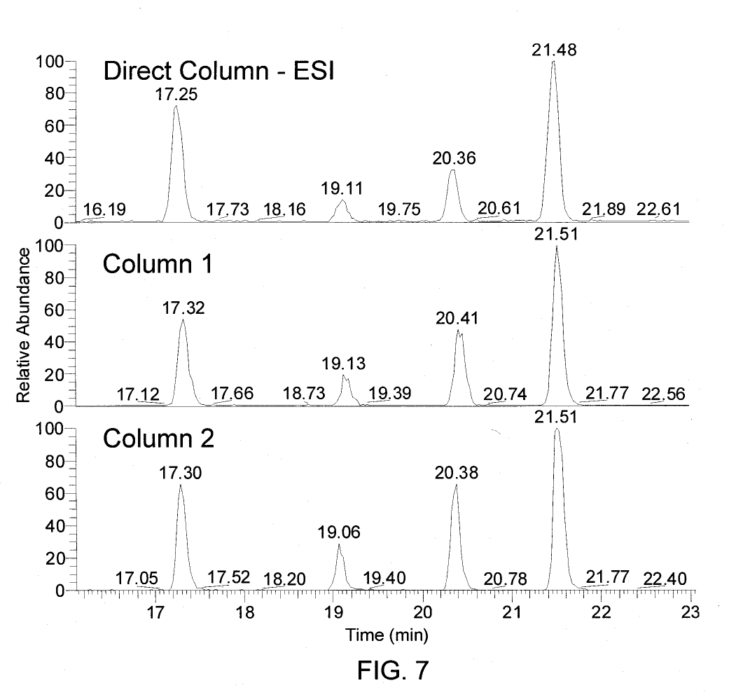

The same comparison is shown in FIG. 6 for a direct injection experiment. The top panel was collected using traditional plumbing, and the bottom panel was collected using a fluidic jumper, in the configuration diagrammed in FIG. 4B. FIG. 7 illustrates a similar comparison with the two column switching experiment. The top panel was collected during a single column direct injection experiment, and the bottom two panels were collected during a two column switching experiment using a system as diagrammed in FIG. 4C. All three chromatograms are similar, again illustrating that the use of a fluidic jumper does not affect performance.

Chemical Synthesis System

Chemical synthesis may be performed in a microfluidic format. The system of the present invention allows flexibility in the number of reactants to be combined, the order in which they are combined, the ratios in which they are combined, and where along the fluid path the products are sampled. A catalyst may be placed in fluidic elements through which the reactants are passed. Embedded sensors can provide realtime feedback control of the feed streams. The fluid may be a liquid or a gas.

Sample Preparation System

For sample preparation, a system may be configured in which the sequence and identity of steps is dictated by the sample to be analyzed. For example, the system may perform one or more of the following: salt removal, filtration, digestion, reduction, alkylation, and removal of high abundance peptides. By selecting the appropriate fluidic elements and fluid jumpers, a user may select which steps are performed and in what order. Multiple steps may be performed on a sample with minimal sample losses, because there is no vial-to-vial transfer steps as were previously required in laboratory processing. EEPROM devices can be used to identify each sample and record data about the steps performed on the sample.

Advanced Controls

The use of heating/cooling elements on the microfluidic chips may be used for additional system flexibility. For example, a cooling element may be used to control the temperature low enough to slow reactions, (e.g., hydrogen/deuterium exchange) allowing the user to label their samples with deuterium. Additionally, a temperature control may be used to carry out a thermal ramp profile on low thermal mass chips to effect enhancements in chromatographic separations in a reproducible manner.

For example, the system may allow users to carry out ‘gradient-like’ liquid chromatography separations using only water as the mobile phase since the salvation properties of water are known to evolve towards those of methanol (a common organic mobile phase modifier) as temperature is increased.

The temperature control could also be used to carry out elevated, reduced or programmed temperature/pressure profiles for synthetic reactions and PCR.

Support Platforms and Increased Throughput Platforms

Multiple manifolds, fluidic jumpers and fluid element chips may be assembled to perform switching between numerous active chips (e.g., columns, reactors, traps, digesters, catalyst chips, etc.), to address issues such as carryover, regeneration, and reconditioning and increase the duty cycle of a sensor or detector (e.g., mass spectrometer) through multiplexing.

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstracts and drawings, and all the steps in any method or process disclosed, may be combined in any combination except combination where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

What is claimed is:

1. A microfluidic processing system comprising:
a. a manifold comprising:
i. at least one inlet;
ii. at least one outlet; and
iii. a plurality of microfluidic chip holders;
b. a fluidic jumper coupled to one of the chip holders;
c. at least two fluidic elements coupled to at least one of the chip holders;
wherein the fluidic jumper controls the fluidic path through the system.

2. The microfluidic system of claim 1 wherein the at least two fluidic elements are on a single microfluidic chip.

3. the microfluidic system of claim 1 wherein the at least two fluidic elements comprise at least one fluidic element on each of two separate microfluidic chips.

4. The microfluidic system of claim 1 wherein at least one of the fluidic elements is selected from the group consisting of a reaction chamber, a sample preparation chamber, a trap and a liquid chromatograph.

5. The microfluidic system of claim 1 wherein at least one of the fluidic elements is selected from a filter, a chromatograph, a bead catcher, an optical sensor, an electrochemical sensor, a temperature sensor and a flow sensor.

6. The microfluidic system of claim 1 wherein the fluidic jumper causes fluid to pass through the at least two fluidic elements in series.

7. The microfluidic system of claim 1 wherein the fluidic jumper causes fluid to pass through the at least two fluidic elements in parallel.

8. The microfluidic system of claim 1 further comprising at least one fluid source coupled to at least one inlet.

9. The microfluidic system of claim 8 further comprising a valve between the at least one fluid source and the inlet to which the fluid source is coupled.

10. The microfluidic system of claim 1 further comprising at least one destination coupled to at least one outlet.

11. The microfluidic system of claim 1 wherein at least one of the fluidic jumper and the fluidic elements is mounted in a chip caddy.

12. The microfluidic system of claim 1 wherein the fluidic jumper and the fluidic elements further comprise a memory encoded with information.

13. The microfluidic system of claim 1 further comprising a heating or cooling element for affecting the temperature of at least one fluidic element.

14. The microfluidic system of claim 1 wherein the manifold further comprises releasable mechanical retainers for retaining the fluidic jumper and the fluidic elements.

15. A method for analyzing fluids comprising the steps of:
a) selecting an apparatus according to claim 1;
b) coupling at least one fluid source to the at least one inlet;
c) passing fluid from the fluid source through the fluidic jumper, at least one of the two fluidic elements and out of the at least one outlet; and
d) determining at least one characteristic of the fluid after it passes through the at least one of the fluidic elements.

16. The method of claim 15 further comprising the step of removing the fluidic jumper and replacing the fluidic jumper with a second fluidic jumper to alter the flowpath through the system.

17. The method of claim 15 further comprising the step of removing at least one of the fluidic elements and replacing the removed fluidic element with a different fluidic element.

18. The method of claim 15 wherein the system further comprises a heating or cooling element for affecting the temperature of at least one fluidic element; and the method further comprises the step of heating or cooling at least one fluidic element to alter the fluid passing therethrough.

19. A kit for performing microfluidic processing of a fluid comprising:
a. a manifold comprising:
i. at least one inlet;
ii. at least one outlet; and
iii. a plurality of microfluidic chip holders;
b. at least one fluidic jumper connectable to the chip holders;
c. a plurality of different fluidic elements connectable to at least one of the chip holders;
wherein at least one fluidic jumper is usable to dictate the fluidic path through the manifold and fluidic elements.

20. The kit of claim 19 further comprising: a plurality of different fluidic jumpers connectable to the chip holders.
